(19) United States
(12) Patent Application Publication
(10) Pub. No.: US 2007/0266501 A1
(43) Pub. Date: Nov. 22, 2007

(54) Superficial Use of Cationic or Amphoteric Polymers on Semifinished Leather Products

(75) Inventors: Gerhard Wolf, Ketsch (DE); Stephan Huffer, Ludwigshafen (DE); Oliver Reese, Mannheim (DE); Jurgen Decker, Speyer (DE); Georg Igl, Weissach (DE); Stefan Schroeder, Neuleiningen (DE); Gunter Scherr, Ludwigshafen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Basf Aktiengesellschaft, Ludwigshafen (DE)

(21) Appl. No.: 10/566,967

(22) PCT Filed: Jul. 30, 2004
(86) PCT No.: PCT/EP04/08607

§ 371 Date: Feb. 2, 2006

(30) Foreign Application Priority Data
Aug. 6, 2003 (DE) 10336453.6

(51) Int. Cl. C14C 11/00; D06P 1/607

(52) U.S. Cl. 8/94.22; 8/94.2; 8/94.21

(57) ABSTRACT

A process for the treatment of leather comprises the following process steps: (a) Application of at least one cationic or amphoteric aqueous treatment composition to leather by roll coating and/or roll application and/or spray application, and subsequently (b) treatment of the leather with an anionic leather treatment composition in a drum.

The present invention relates to a process for the treatment of leather and the use of water-soluble, cationic or amphoteric assistants for the surface finishing of leather.

The production of leather and furs from hides and skins usually takes place in a plurality of steps. After the preparatory work of the beamhouse, such as unhairing, fleshing, deliming and bating, a typical sequence consists of tanning, retanning, dyeing, fatliquoring and finishing. The individual operation can also be divided into further subunits.

The object of tanning is to convert the skin or the hide into a stable material which does not soil. This is achieved by converting collagen fibers in the skin or in the hide into a stable product which does not rot. Moreover, the tanning improves a number of properties of the skin or of the hide, for example dimensional stability, abrasion resistance, resistance to chemicals and heat, improved flexibility and the ability to withstand repeated cycles of becoming wet and dry.

Retanning is understood as meaning the aftertreatment of pretanned leather in order to optimize color, levelness, softness, body and the behavior toward water (hydrophobic character) and to fix tanning agents. After the aftertreatment, the generally anionic aftertreatment compositions are fixed by cationic polymers.

In particular, the tanning, retanning and dyeing are usually carried out in tanning drums using aqueous tanning agent/retanning agent solutions or dispersions or dye solutions. A major part of the tanning agents and tanning assistants used is added in the form of a pulverulent solid and/or solution to the tanning drums (liquors).

The aftertreatment of leather is described, for example, in Das Leder, Issue 4/1996, pages 74 to 83, and Das Leder, Issues 7+8/1996, pages 157-171.

A disadvantage of such aftertreatment methods in tanning drums is that, for example, the dye or the fat is not fixed homogeneously on the leather, so that targeted modification of the leather is not possible. In particular, in the case of a drum treatment, no differentiation between the flesh and crust upper side of the leather is possible. Moreover, pronounced but not targeted or desired irregularities form in some cases. Furthermore, particularly in the case of the dyeing of the leather, large amounts of dyes are required. The leathers treated in this manner moreover generally have a very low fastness level.

It is an object of the present invention to provide a process for the treatment of leather which avoids the disadvantages of the processes of the prior art.

We have found that this object is achieved by a process for the treatment of leather.

In a first embodiment, the process for the treatment of leather comprises the following process steps:
(a) Application of at least one cationic or amphoteric aqueous treatment composition to leather by roll coating and/or roll application and/or spray application and subsequently
(b) treatment of the leather with an anionic leather treatment composition in the drum.

The exact procedure for roll coating, roll application and spray application is described in Volumes 5 and 6 of Bibliothek des Leders and is known to a person skilled in the art.

In the novel process, the leather is, if appropriate, dried between the process step (a) and (b) and after process step (b). The drying can be carried out by conventional methods known to a person skilled in the art, for example by hanging out to dry, vacuum drying or drying on a toggle frame. Depending on operating conditions, the temperatures may be from 40 to 90° C.

The present invention furthermore relates to a process for the treatment of leather in a second embodiment, which comprises the following process steps:
(a) Application of at least one cationic or amphoteric aqueous treatment composition to leather by roll coating and/or roll application and/or spray application with simultaneous use of organic and/or inorganic pigments and/or anionic leather treatment compositions,
(b) if appropriate, drying of the leather treated in this manner.

The cationic or amphoteric aqueous treatment composition used in the novel process preferably comprises an epichlorohydrinamine polymer. The polymer used in the novel process preferably has a weight average molar mass of from 1·10² to 2·10⁵, preferably from 1·10³ to 1·10⁵, particularly preferably from 4·10³ to 5·10⁴, g/mol.

The concentration of the polymer in water is preferably from 5 to 50, particularly preferably from 10 to 35, in particular from 18 to 25, % by weight, based in each case on water.

In a particular embodiment of the novel process, the cationic or amphoteric aqueous treatment composition is composed of amine units and epichlorohydrin units. The ratio of amine units to epichlorohydrin units is preferably from 0.8:1.2 to 1.2:0.8, preferably from 0.9:1.1 to 1.1:0.9, particularly preferably from 0.92:1.08 to 1.08:0.92.

The amine units may be formed from a single amine or from a plurality of different amines, for example 2 or 3. In a particular embodiment of the novel process, the epichlorohydrinamine polymer comprises amine units which are composed of from 0.5 to 0.8, preferably from 0.6 to 0.7, parts of dimethylaminopropylamine and from 0.2 to 0.5, preferably from 0.3 to 0.4, parts of benzylamine.

The cationic assistant preferably has at least two general structural units (I) and (II) 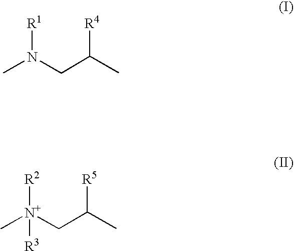
where R¹, R², R³, R⁴ and R⁵ have the following meanings:
R¹ and R²: —(CH₂)₃N(CH₃)₂, —CH₂C₆H₅, —(CH₂)₂NH₂, —(CH₂)₂OH, —(CH₂)₂NH(CH₂)₂NH₂
R³: H or alkyl,
R⁴ and R⁵: H or OH.

The general structural units (I) and (II) are present in the epichlorohydrinamine polymer randomly, alternately or as blocks.

The anionic leather treatment composition used after the treatment with the cationic or amphoteric aqueous treatment composition is preferably selected from the group consisting of dyes, fatliquoring agents and retanning agents. The anionic leather treatment composition may simultaneously have a plurality of the abovementioned properties (dyeing, fatliquoring retanning). Suitable dyes are the leather dyes usually used, for example natural dyes, and furthermore synthetic dyes, such as anionic dyes, metal complex dyes, direct dyes, cationic dyes or sulfur dyes. Dyes are also to be understood as meaning pigments, i.e. dyes substantially insoluble in water. Examples of suitable pigments are Helizarin pigments (nonionic) or Lepton pigments (anionic). In addition, E. Heidemann, in Fundamentals of Leather Manufacture, Verlag Eduard Roether K G, pages 432 to 448, describes suitable dyes.

Suitable fatliquoring agents are the conventional compositions customary for the fatliquoring of leather. They are preferably
a) fatliquoring agents based on animal fats, e.g. fish oil, neatsfoot oil, wool fat or lard oil,
b) fatliquoring agents based on vegetable fats, e.g. castor oil, coconut oil or olive oil,
c) synthetic fatliquoring agents, e.g. chlorination and sulfochlorination products of paraffin hydrocarbons, synthetic fatty esters and ester oils,
d) mineral oils and other petrochemical products.

These fatliquoring agents are preferably modified by sulfation, sulfition or formation of sulfonic acids, so that they are soluble or emulsifiable in water. It is also possible to use a fatliquoring agent mixture in which a part has emulsifying properties and thus acts as an emulsifier for the remaining part. For example, sulfated fatty alcohols are suitable for this purpose. These fatliquoring agents are preferably used as aqueous solutions or emulsions.

Suitable mineral tanning agents are the known chromium, aluminum, iron or zirconium salts, for example chromium(III) chloride or sulfate, chromealum, if appropriate basic aluminum chloride or sulfate, iron(III) chloride or sulfate, zirconium oxychloride and zirconium sulfate. The polymeric retanning agents are, for example, polyacrylates, copolymers comprising acrylates, polyurethanes or polybutadienes. In addition, it is also possible to use synthetic retanning agents, for example synthetic, anionic, aromatic tanning agents (also referred to as syntans), and the uncondensed precursors thereof or the alkali metal and ammonium salts of these compounds.

Suitable precursors are, for example, naphthalene, biphenyl, terphenyl, phenols, cresols, 4,4-dihydroxydiphenyl sulfone, β-naphthol, dihydroxybenzenes, resorcinol, 2,2-bis(hydroxyphenyl)propane and diaryl ethers, such as diphenyl ether and ditolyl ether, which are sulfonated in a manner known per se to give the anionic uncondensed precursors.

Examples of anionic aromatic syntans are those which are obtainable by condensation of the sulfonated precursors alone or together with further, generally unsulfonated precursors with formaldehyde and/or urea, for example
(I) condensates of sulfonated phenol or cresol and formaldehyde,
(II) condensates of naphthalenesulfonic acid and formaldehyde,
(III) formaldehyde condensates of 4,4-dihydroxyphenyl sulfones with (hydroxy)arylsulfonic acids,
(IV) formaldehyde condensates or sulfo-containing aromatic hydroxy compounds with aralkyl halides,
(V) urea/formaldehyde condensates of phenols and phenolsulfonic acids,
(VI) reaction product of phenol and a sulfonating agent, the molar ratio (phenol):(SO₃) being (1):(1.1-2.2),
(VII) condensates of sulfonate diaryl ethers and formaldehyde,
(VIII) condensates of sulfonated bi- or terphenyls and formaldehyde,
(IX) condensates of 4,4′-dihydroxydiphenyl sulfone and sulfonated 4,4′-dihydroxydiphenyl sulfone with formaldehyde and
(X) formaldehyde condensates of diaryl ether sulfonic acid and 4,4′-dihydroxyphenyl sulfone.

The condensates of the types (I)-(III), (V) and (VII)-(X) are disclosed, for example, in Ullmanns Enzyklopdäie der technischen Chemie, Vol. 16, (4), 140 (1979) and can be prepared by the processes described in the references given there.

Condensates of the type (IV) and the preparation thereof are disclosed in GB-C-986621.

Condensates of the type (V) and the preparation thereof are disclosed in GB-C-890150 and 935678.

The reaction product of the type (VI) and the preparation thereof are disclosed in EP-A-0 245 205. These reaction products can be condensed by methods known per se to give products of the type (V) (cf. for example GB-C-683084).

These retanning agents are known and are to a large extent commercially available.

In a preferred embodiment of the present invention, the cationic or amphoteric aqueous treatment composition in process step (a) is applied only to the crust surface of the leather so that the anionic leather treatment composition is preferably bound on the side of the leather.

The present furthermore relates to the use of cationic or amphoteric aqueous treatment compositions for the surface treatment, in particular surface finishing, of semifinished leather products. In a preferred embodiment, a cationic or amphoteric aqueous treatment composition as described above is used.

These cationic or amphoteric aqueous treatment compositions are preferably used for fixing dyes, pigments and/or fats on a leather surface, in particular crust upper side, instead of the flesh side, for reducing the use of dye in the case of solid hues, for improving the fastness of pigment coats, for the production of spotted leather, for the production of fashion effects, for the production of two-color effects by subsequent drum dyeing and/or for achieving a higher fastness level.

The present invention furthermore relates to semifinished leather products which have been treated by water-soluble, cationic or amphoteric polymers. Regarding these water-soluble, cationic or amphoteric polymers, reference is made to the above statements. Preferably, a suitable cationic or amphoteric aqueous treatment composition is an epichlorohydrinamine polymer as described above.

The present invention has a large number of advantages over the prior art.

The aqueous, cationic or amphoteric assistants are adsorbed in a controlled manner onto the leather. Consequently, for example, a dye or a fat is fixed very well on the leather. By means of the novel process, it is therefore possible to obtain a high fastness level of the treatment leather (color fastness) and at the same time to reduce the individual repair costs. Moreover, the leather quality as a whole is improved, in particular with regard to levelness, depth of color and number of defects. By combining the novel process with the novel cationic assistant, it is possible to produce modifications of the leather surface. For example, only certain regions of the leather may be dyed or fatliquored. In addition, the novel process permits the production of printed or patterned leather. Examples of these are cloud effects or targeted irregularity on the leather.

The examples which follow illustrate the invention.

### WORKING EXAMPLES

1. Preparation of a epichlorohydrin-dimethylaminopropylamine/benzylamine polymer according to the invention:
   1020 g (10 mol) of dimethylaminopropylamine and 267.5 g (2.5 mol) of benzylamine are mixed in 1519.1 g of water. The solution/suspension is heated to 50° C. for 1 hour. 931 ml of epichlorohydrin (1098.4 g/11.875 mol) are then added dropwise at a rate of 16 ml/min until free alkylating agent (Preuβmann test) can no longer be detected. Stirring is then effected for two hours at 85° C. until free alkylating agent can no longer be detected. The reaction mixture is cooled and is brought to a pH of 7.0 with 85% strength formic acid.
2. Procedure for improving the fastness level (without pigment):
   A commercial, undyed chrome crust leather completely tanned or produced using synthetic, vegetable or mineral tanning agents, fatliquored with commercial fatliquoring agents, is treated by means of spray application with 50 parts, dissolved in 950 parts of water, of the novel cationic compound prepared as above, and is then dried. The crust leather treated in this manner is then soaked with 600%, based on the crust weight, of water at 40° C. for 90 minutes in a drum. The liquor is discharged, and dyeing is effected in 200% liquor at 30° C. with 4% of a commercial dye for 90 minutes. After 90 minutes, a further 300% of water is added at 50° C. and dyeing is effected for a further 30 minutes. By means of 2.5% strength formic acid, added in two portions, the liquor is acidified to a pH of 3.5 in the course of 60 minutes and is dried. The dyeing of the leather thus obtained was substantially more intense than in a comparative experiment without the use of the cationic assistant.
3. Procedure for improving the fastness level (with pigment)
   Analogously to the above experiment, a chromium-containing crust leather was treated once with a solution of 150 parts of a commercial pigment, 50 parts of the novel compound prepared as above and 50 parts of isopropanol in 750 ml of water by means of spray application and was briefly dried. The crust leather treated in this manner was then whitewashed with 1000%, based on the shaved weight (weight of the hide material in the drum), of water at 40° C. for 10 minutes in the drum. The liquor is discharged and dyeing is effected at 40° C. with 3% of two commercial dyes for 80 minutes. By means of formic acid, added in two portions, the liquor is acidified to a pH of 3.5 in the course of 50 minutes and is dried. The dyeing of the leather was substantially more intense than the comparative experiment without the use of the novel compound. Likewise, the levelness of the leather was substantially increased. In particular, the lightfastness was substantially improved in comparison with the blank test.
4. Procedure for modifying the surface
   By means of a commercial roll coating machine and an engraved roll, a mixture of 50 parts of the novel compound prepared as above and 950 parts of water is applied to an undyed chromium-containing crust leather. The leather is dried and then dyed analogously to the above process. After drying of the leather, the print of the engraving was clearly recognizable on the leather through a deeper color. The surface leathers can thus be easily modified individually by means of printing processes.
5. Description of the Preuβmann test using dimethyl sulfate as an example

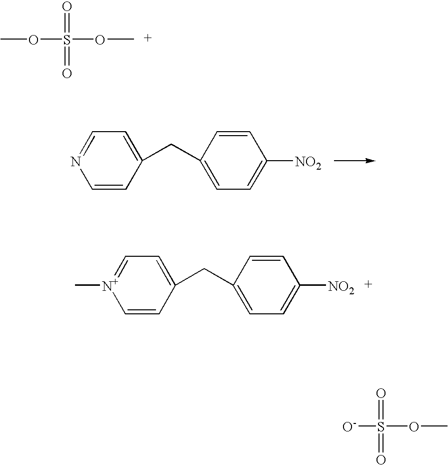

3 to 4 drops of the solution to be investigated for free alkylating agent are introduced into a test tube, 1 ml of buffer solution is added and 1 ml of Preuβmann reagent is added. The resulting solution is heated to 80° C. for 30 minutes and cooled with ice water, and 1 ml of a carbonate solution is added. In the presence of a free alkylating agent, the solution acquires an intense blue color.

| | |
|---|---|
| Buffer solution: | Weigh 40.85 g of potassium hydrogen phthalate |
| | into 1 l of distilled water, add 0.4 ml of 0.2 N |
| | sodium hydroxide solution to 99.6 g of this |
| | solution and make up to 200 ml with distilled |
| | water |
| Preuβmann reagent: | 4-(p-nitrobenzyl)pyridine as a 5% strength |
| | solution in acetone |
| Carbonate solution: | Dissolve 138.21 g of potassium carbonate in 1 l |
| | of distilled water |

1-12. (canceled)

13. A process for the treatment of leather, comprising:
(a) applying at least one cationic or amphoteric aqueous treatment composition to leather by roll coating and/or roll application and/or spray application and subsequently
(b) treating the leather with an anionic leather treatment composition in a drum.

14. The process as claimed in claim 13, wherein the leather is dried between process step (a) and (b) and/or wherein the leather resulting from process step (b) is dried.

15. A process for the treatment of leather, comprising:
(a) applying at least one cationic or amphoteric aqueous treatment composition to leather by roll coating and/or roll application and/or spray application with simultaneous use of organic and/or inorganic pigments and/or anionic leather treatment compositions and
(b) optionally drying the leather treated in this manner.

16. The process as claimed in claim 13, wherein the cationic or amphoteric aqueous treatment composition used in process step (a) is an epichlorohydrinamine polymer, the polymer having a weight average molar mass of from 1·10² to 2·10⁵ g/mol.

17. The process as claimed in claim 15, wherein the cationic or amphoteric aqueous treatment composition used in process step (a) is an epichlorohydrinamine polymer, the polymer having a weight average molar mass of from 1·10² to 2·10⁵ g/mol.

18. The process as claimed in claim 13, wherein the cationic or amphoteric aqueous treatment composition used in process step (a) comprises amine units and epichlorohydrin units, the ratio of amine units to epichlorohydrin units being from 0.8:1.2 to 1.2:0.8.

19. The process as claimed in claim 15, wherein the cationic or amphoteric aqueous treatment composition used in process step (a) comprises amine units and epichlorohydrin units, the ratio of amine units to epichlorohydrin units being from 0.8:1.2 to 1.2:0.8.

20. The process as claimed in claim 18, wherein the amine units comprise from 0.5 to 0.8 part of dimethylaminopropylamine and from 0.2 to 0.5 part of benzylamine.

21. The process as claimed in claim 19, wherein the amine units comprise from 0.5 to 0.8 part of dimethylaminopropylamine and from 0.2 to 0.5 part of benzylamine.

22. The process as claimed in claim 13, wherein the treatment composition in process step (a) has at least two general structural units (I) and (II) 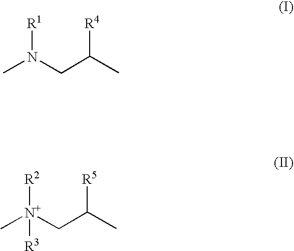
where R¹, R², R³, R⁴ and R⁵ have the following meanings:
R¹ and R² —(CH₂)₃N(CH₃)₂, —CH₂C₆H₅, —(CH₂)₂NH₂, —(CH₂)₂OH, —(CH₂)₂NH(CH₂)₂NH₂
R³: H or alkyl,
R⁴ and R⁵: H or OH.

23. The process as claimed in claim 15, wherein the treatment composition in process step (a) has at least two general structural units (I) and (II) 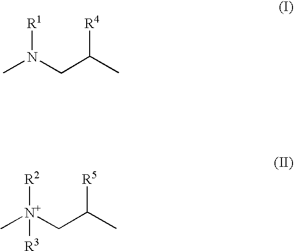
where R¹, R², R³, R⁴ and R⁵ have the following meanings:
R¹ and R² —(CH₂)₃N(CH₃)₂, —CH₂C₆H₅, —(CH₂)₂NH₂, —(CH₂)₂OH, —(CH₂)₂NH(CH₂)₂NH₂
R³: H or alkyl,
R⁴ and R⁵: H or OH.

24. The process as claimed in claim 13, wherein the anionic treatment composition is at least one composition selected from the group consisting of dyes, fatliquoring agents and retanning agents.

25. The process as claimed in claim 15, wherein the anionic treatment composition is at least one composition selected from the group consisting of dyes, fatliquoring agents and retanning agents.

26. The process as claimed in claim 13, wherein the cationic or amphoteric aqueous treatment composition in process step (a) is applied only to the crust surface of the leather.

27. The process as claimed in claim 15, wherein the cationic or amphoteric aqueous treatment composition in process step (a) is applied only to the crust surface of the leather.

28. A process for fixing dyes, pigments or fats on a leather surface, for reducing the dye use in solid hues, for improving the fastness of pigment coats, for the production of spotted leather, for the production of fashion effects, for the production of two-color effects by subsequent drum dyeing or for achieving a higher fastness level, comprising:
(a) applying at least one cationic or amphoteric aqueous treatment composition to leather by roll coating and/or roll application and/or spray application and subsequently
(b) treating the leather with an anionic leather treatment composition in a drum.

29. A process for fixing dyes, pigments or fats on a leather surface, for reducing the dye use in solid hues, for improving the fastness of pigment coats, for the production of spotted leather, for the production of fashion effects, for the production of two-color effects by subsequent drum dyeing or for achieving a higher fastness level, comprising:
(a) applying at least one cationic or amphoteric aqueous treatment composition to leather by roll coating and/or roll application and/or spray application with simultaneous use of organic and/or inorganic pigments and/or anionic leather treatment compositions and
(c) optionally drying the leather treated in this manner.
